(19) United States
(12) Patent Application Publication
(10) Pub. No.: US 2004/0039994 A1
(43) Pub. Date: Feb. 26, 2004

(54) System and process for communication between Java server pages and servlets

(76) Inventor: Colm Donal Duffy, Dublin (IE)

Correspondence Address: BROWN, RUDNICK, BERLACK & ISRAELS, LLP., BOX IP, 18TH FLOOR, ONE FINANCIAL CENTER, BOSTON, MA, 02111, US

(21) Appl. No.: 10/064,836

(22) Filed: Aug. 22, 2002

(51) Int. Cl. G06F 15/00

(52) U.S. Cl. 715/517; 715/530

(57) ABSTRACT

The present invention addresses the above-described problem by channeling all the communication between JSP and servlets via a single servlet, which delegates to a request and screen flow handlers those objects that are in charge of looking after the details of the user's activities and navigation. The invention provides a Front Controller pattern and uses the servlets based on the Front Controller pattern. The pattern utilizes loose coupling between business processing and screen flow, using HTTP actions that call upon specialized implementations of the handler interfaces. The business processing and screen flow, therefore, can change with no or negligible effect on each other.

### BACKGROUND OF INVENTION

The present invention relates to communication between different architectural layers of Java Server Pages and Servlets. In particular, the invention relates to designing communication between JSP and a single servlet responsible for defining request on screen flow handlers controlling a user's interaction and navigation.

Building web pages in response to a user's requests is a useful and necessary functionality often required for a successful operation of many Internet-based businesses. Often web pages need to be built based on a user's search string, such as pages generated by search engines or programs that process orders for e-commerce sites. A weather report might serve as an input for dynamically built pages, returning either the same page if the input hasn't changed or returning an updated page for a different input. Information provided by proprietary databases, such as the current bids in online auctions, prices or inventory, can also be used to build dynamic web pages. Dynamic web page building is accomplished by using servlets, which are the programs that run on a web server and build web pages by facilitating the manipulation of user requests and communicating directly with the web server.

Java Server Pages are a server side technology allowing one to facilitate dynamic web page building. The server-side JSP elements are called actions that perform server-side tasks. JSP have dynamic scripting capability that works together with HTML code, separating the page logic from the static elements of the page (the static elements being the actual design and display of the page). With the help of the JSP technology a system designer can put segments of the servlet code directly into a static HTML page, allowing a user to mix regular, static HTML pages with dynamically generated ones. The Java source code and its extensions embedded in the HTML provide the HTML with more functionality, such as, for example, dynamic database queries. When a JSP page is loaded by a browser, the servlet code executes itself and the application server creates, compiles, loads and runs a background servlet to execute the servlet code segment and return an HTML page or print an XML report. The best advantage of java Server Pages is in their not being restricted to any particular platform or server architecture.

Developing, building and deploying web-based enterprise applications online is done with Java 2 Platform Enterprise Edition (J2EE), which is a platform-independent Java environment. The J2EE platform comprises a set of services, Application Program Interfaces (APIs), and protocols providing various functionality to multilayered web-based applications. The key features and services of J2EE include the support of pure HTML and Java applets, Enterprise Java Beans (EJB), Database Connectivity (JDBC), and Java API servlets. J2EE usually relies on the JSP and servlet code to create HTML or other data for the client. EJB is a server-side component architecture for the development and deployment of the distributed object systems, it provides a layer where the platform's logic is stored and is responsible for such services as threading, concurrency, security and memory management. JDBC is a standard interface for Java databases. The Java servlet API serves to enhance consistency for developments without the need to use a graphical user interface.

When a user types in a command or clicks on a link, a request is sent to an application server through a servlet. In a simple case of a thin-layered architecture, shown in FIG. 1, the servlet uses Java Naming and Directory Interface (JNDI) APIs to look up and pass the request onto a Stateless Service Bean (JavaBeans are reusable software components designed to be manipulated visually by a software development environment). The Bean communicates with the application by performing calculations on the J2EE application server and passes the information from the application back to the servlet and then back to the user, displaying the requested page or other information. In a more complex case of a multilayered architecture, shown in FIG. 2, the web browser and HTML pages are powered by the servlet/JSP technology. For example, if a user wants to view a list of certain entries of interest, the user clicks on the link displayed on a screen, starting the communication process between the HTML page and the end point of the request. In accordance with the request, the HTML/JSP page posts up an action string to the appropriate servlet. The servlet reads the session to ascertain which session has made the request, calls a Session Bean after which the appropriate information is retrieved either from an Entity Bean or from a database. The servlet returns the requested list of certain entries of interest to the user's screen, completing the communication cycle.

In a basic request model shown in FIG. 2, an HTTP request is sent by a browser 20 to a JSP page 25 residing on a web server JSP program controls communication with business and logic JavaBeans components 28, then displays the results by generating a dynamic HTML code mixed with static HTML code. Beans 28 can be JavaBeans or Enterprise JavaBeans components. More complicated requests can comprise addressing other JSP pages or Java Servlets from the requested JSP.

Some known system designs incorporate multiple servlets performing services for different functions of an application, which means that each JSP requires a separate form to communicate with each requested servlet. Such a multiple servlet design often becomes a problem, especially when the system has to be scaled or maintenance of the code has to be performed. Therefore, it would be desirable to have a system design that allows the JSP communicate directly with only one servlet at all times regardless the type of request received by the servlet.

### SUMMARY OF INVENTION

The present invention addresses the above-described problem by channeling all the communication between JSP and servlets via a single servlet, which delegates to a request and screen flow handlers those objects that are in charge of looking after the details of the user's activities and navigation. The invention provides a Front Controller pattern and uses the servlets based on the Front Controller pattern. The pattern utilizes loose coupling between business processing and screen flow, using HTTP actions that call upon specialized implementations of the handler interfaces. The business processing and screen flow, therefore, can change with no or negligible effect on each other.

The architecture corresponding to the implementation of the Front Controller comprises a FrontControllerServlet class, serving to fire the relevant RequestHandler and/or FlowHandler for a current HTTP Action, a Request Handler Interface, including the ProcessRequest method called by the FrontControllerServlet, and a FlowHandler interface, including the ProcessFlow method called by the FrontControllerServlet. In an implementing class, the ProcessRequest method carries out business processing using the request object. The ProcessFlow method uses the information available in the request to decide which screen to display next.

According to the principles of the present invention, the system directs all HTTP requests (subsequent to the initial login request) to an instance of the FrontController Servlet. This servlet uses the HTTPActionManager class to map the unique HTTP action, contained within the request, to any relevant RequestHandler and/or FlowHandler.

### BRIEF DESCRIPTION OF DRAWINGS

FIG. 1 is a schematic illustration of a thin-layer architecture.

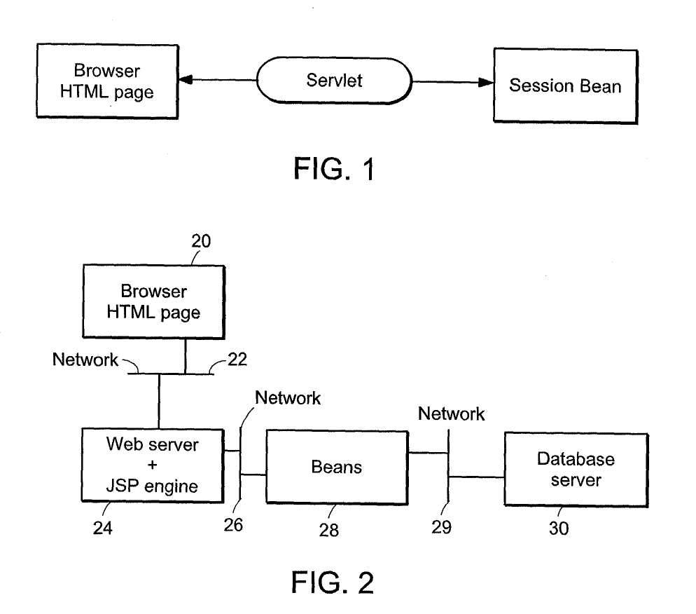

FIG. 2 is a schematic illustration of a multi-layer architecture.

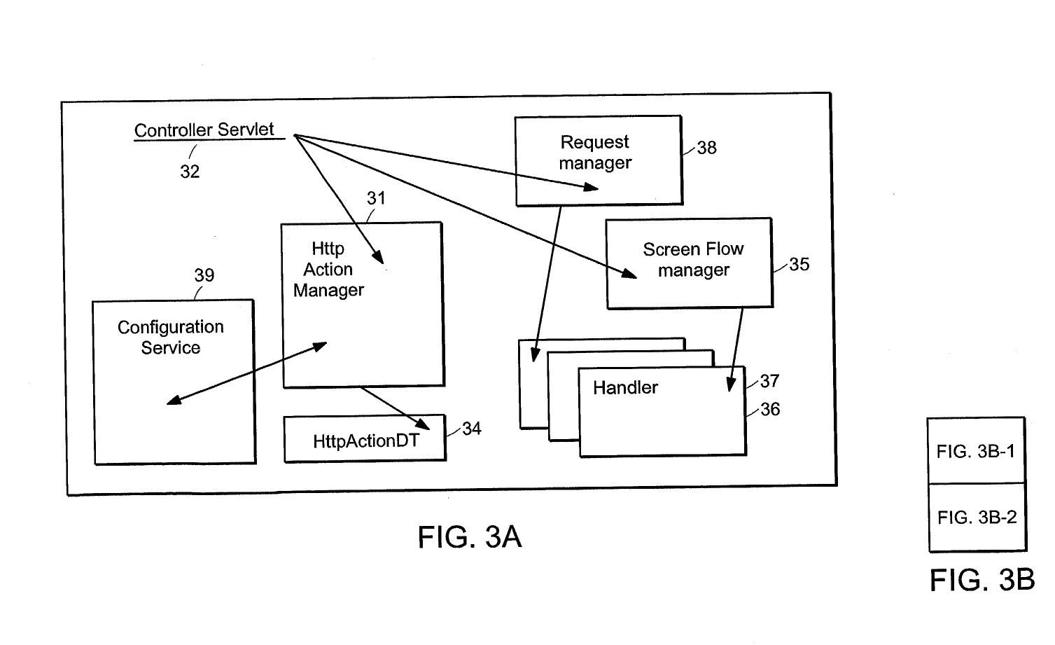

FIG. 3a is a diagram detailing the Front Controller design.

FIG. 3b is a diagram illustration a communication process to and from a FrontControllerServlet.

FIG. 4 is a schematic illustration of action-based communication.

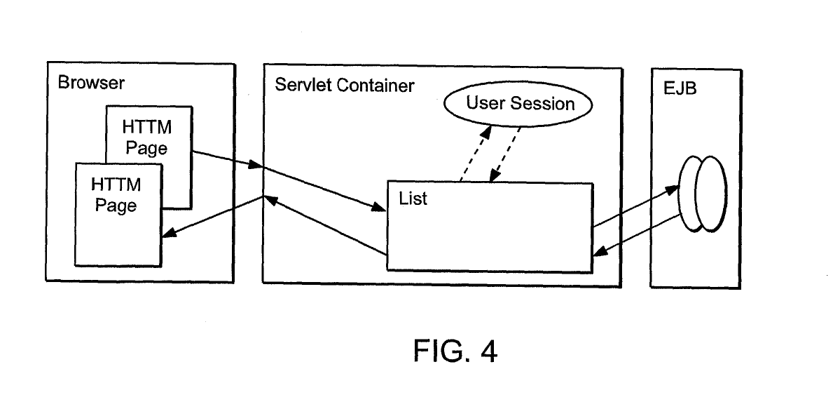

FIG. 5 is a schematic illustration of Screen Flow Handlers.

FIG. 6 is a schematic illustration of Request Handlers.

FIG. 7 is a schematic illustration of a session request id concept.

FIG. 8 is a screen shot of an example of a Front End Spec document.

FIG. 9 is a schematic illustration of a session at the client.

### DETAILED DESCRIPTION

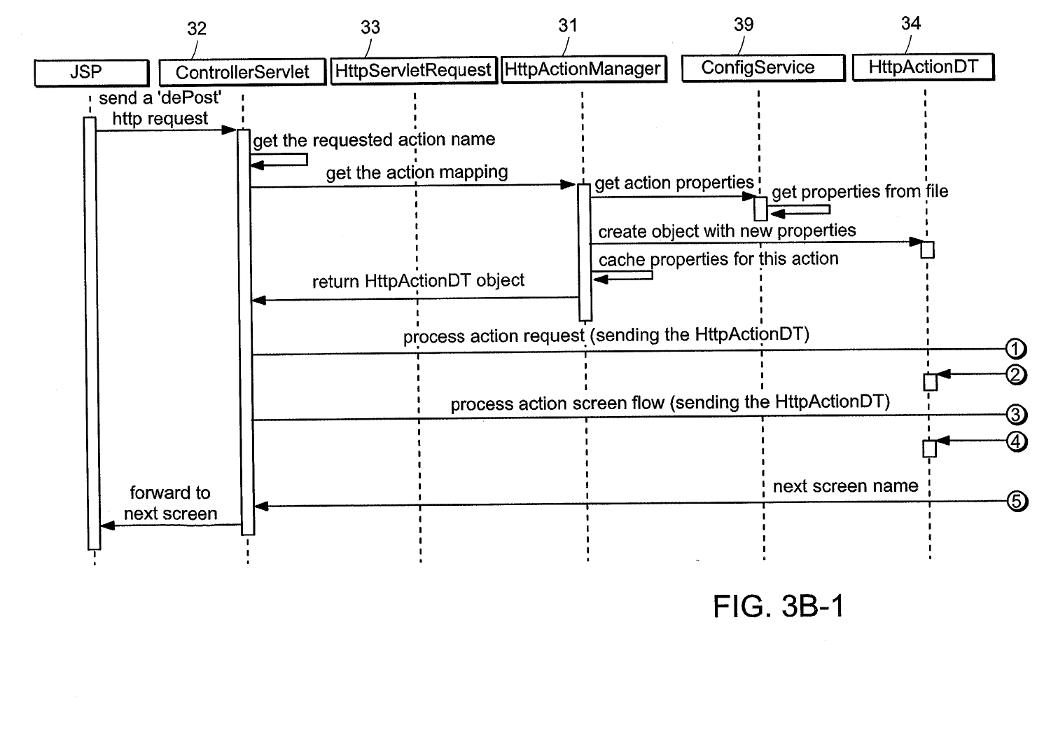

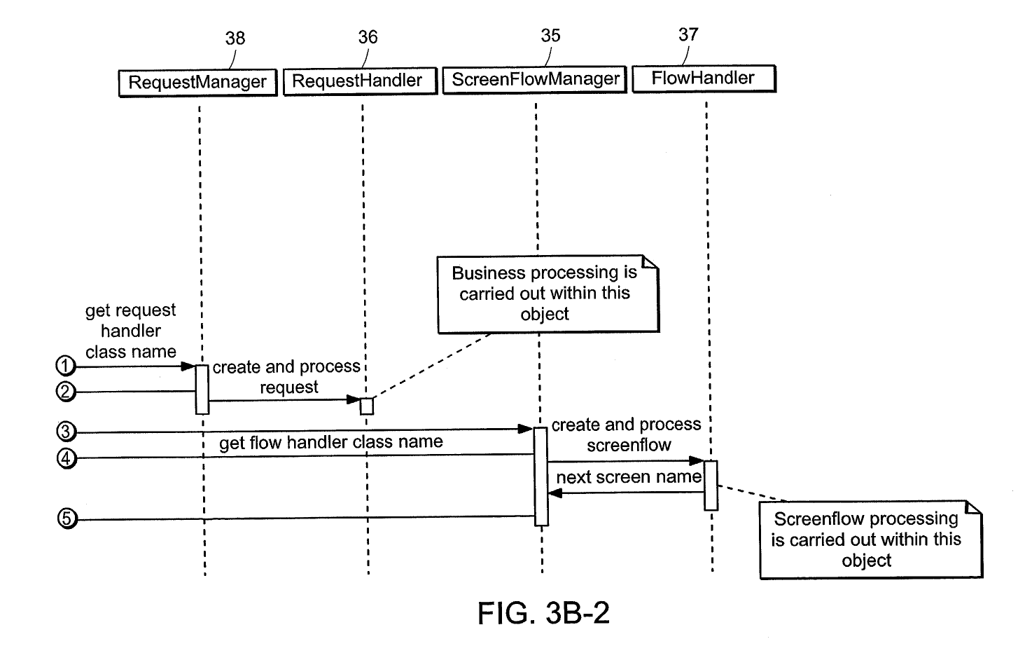

The FrontControllerServlet 32 shown in FIG. 3a comprises a Configuration Service 39, an HttpActionManager 31, a RequestManager 38, and a ScreenFlowManager 35. The Configuration Service 32 stores details of each action within a configuration file which, in turn, is stored in a location where it can be accessed and read by a WebLogic Sever. An HttpActionManager 31 is a class used exclusively by the FrontControllerServlet 32, the class helping the Servlet to manage the retrieval of the action details from the Configuration Service. The RequestManager 38 is an exclusive class delegating control functions to the appropriate Request Handler 36 (shown in FIG. 3b). The ScreenFlowManager 35 is also an exclusive class delegating the control function to the appropriate Flow Handler 37. As illustrated in FIG. 3a, the FrontControllerServlet 32 sends a request to HttpActionManager 31 in order to get action properties from an action name. The HttpActionManager 31 in turn sends the request to the Configuration Service 39 to request a file read from a properties file to return all the associated details of the file name. The HttpActionManager 31 also communicates with an HttpActionDT 34 to create a new data transfer object and cache this new object for later retrieval. The FrontControllerServlet 32 also delegates the request to the RequestManager 38 to perform the business logic, which RequestManager requests a Handler to get the appropriate class from the HttpActionDT 34 to perform the required logic. The communication from the Servlet to the ScreenFlow Manager 35 delegates the screen flow of the manager to perform the navigation and return the destination screen to the Servlet.

To describe an action, it is helpful to consider what happens when a user makes a request, which means that a new screen responsive to the request has to be generated and displayed to the user. When a new screen needs to be developed for an application, all the instructions coming from the user need to have a complete action definition complying with the following standard: the action name, the action properties, and a correlation between the actions and the application name. The action name is usually a unique name explaining what action the user has requested to perform. For example, if the user requested to see a list of requisitions, an action would be called “ListRequisitions” and it would have the following properties:

useRequestHandler: comprises either a true or false value informing the FrontControllerServlet whether this action needs to use a Request Handler.

useScreenFlowHandler: comprises either a true or false value informing the FrontControllerServlet whether this action needs to use a Flow Handler.

requestHandler: the fully qualified class name of the Request Handler to be used. This class name is only read if the property useRequestHandler is true.

flowHandler: the fully qualified class name of the Flow Handler to be used. This class name is only read if the property useScreenFlowHandler is true.

targetScreenName: the list of available screen name ids that this action can navigate to.

defaultScreenName: used instead of TargetScreenName where only one screen is available to the user and remains constant throughout the application.

All actions are associated to the application name, so that multiple action lists can be read by the Application Server hosting multiple applications within a single Virtual Machine. An example of how the action properties look for a particular application is illustrated below:

SupplierApp.CreateCommentSend.useRequestHandler=true-attribute

SupplierApp.CreateCommentSend.useScreenFlowHandler=true-attribute

SupplierApp.CreateCommentSend.requestHandler=com.marrakech.billing.supplierapp.servlets.

SupplierApp.CreateCommentSend.flowHandler=com.marrakech.billing.supplierapp.servlets.han

SupplierApp.CreateCommentSend.targetScreenName=UK_VIEW_BILLING_DOC_INVOICE,\jsp pages names UK_VIEW_BILLING_DOC_DEBIT_NOTE,\UK_VIEW_BILLING_DOC_CREDIT_NOTE,\MEX_VIEW_BILLING_DOC_INVOICE,\MEX_VIEW_BILLING_DOC_DEBIT_NOTE,\MEX_VIEW_BILLING_DOC_CREDIT_NOTE

SupplierApp.ListBillingDocs.useRequesthandler=truesupplierApp.ListbillingDocs.usescreenFlow

SupplierApp.ListbillingDocs.requesthandler=com.marrakech.billing.supplierapp.servlets.handle

SupplierApp.ListbillingDocs.flowHandler=com.marrakech.billing.supplierapp.servlets.handlers.L

Referring now to FIG. 3b, illustrated there is the process of completing a user request by using the FrontControllerServiet 32. FIG. 3b follows the above-described example of making the “ListRequisitions” request within the “SupplierApp” application. Any user request received by the system has a mandatory “action” parameter, which contains a string describing what action the user desires to perform. The relevant action parameter is stored in a parameter list of an HttpServletRequest object.

The FrontControllerServlet 32 receives from an Http Post a list of string values stored in the parameter list. The string is then passed to an HttpActionManager 31 which retrieves the list of action properties from the Configuration Service 39. The class makes the necessary calls of the Config class returning all properties that have the “SupplierApp.ListRequisitions” pre-appended to the above-described default properties. All the details are returned and stored in an HttpActionDT 34, which acts as a data transfer object allowing easy access to the values of these retrieved properties. It should be noted that any additional calls to this same action will not travel via the Configuration Service 39 again, since the HttpActionManager 31 caches each result of the initial retrieval, therefore speeding up the return of the populated HttpActionDT 34. With all the necessary action information now available, the FrontControllerServlet 32 can proceed with the request by referencing the HttpActionDT 34 to discover if a Request Handler 36 is required for this action. If the Request Handler 36 is required, then the Front Controller 32 delegates further processing activity to a RequestManager 38.

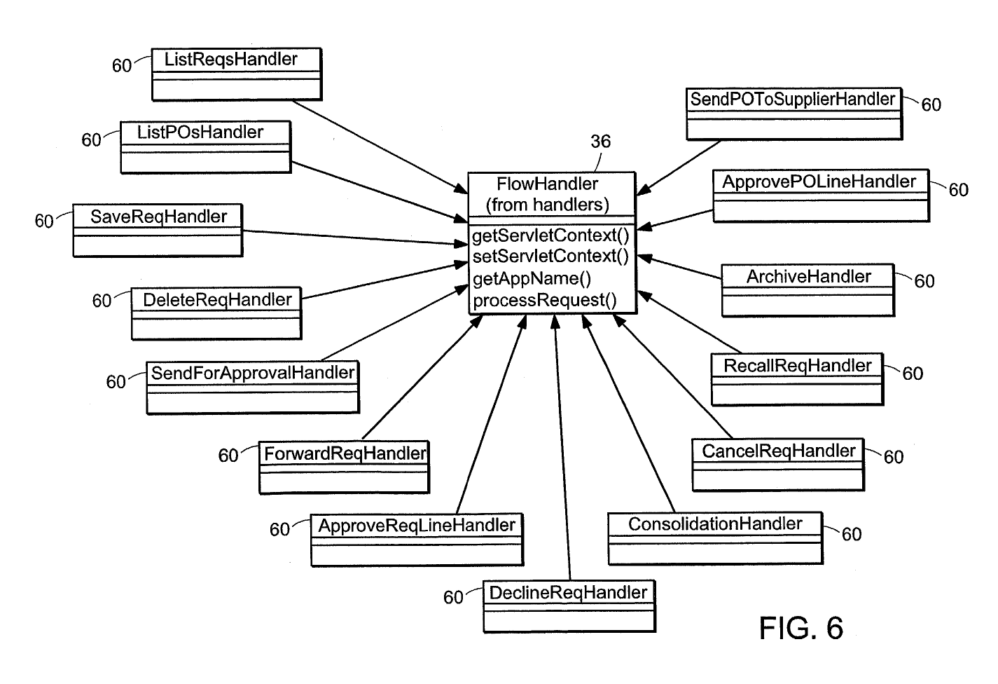

The RequestManager 38 reads the requestHandlervalue from the HttpActionDT 34 and performs a class lookup for that fully qualified class name necessary to process the user's request. The function of the Request Handler 36 is primarily to monitor data processing of the action, attending to any exceptions where they occur. For example, when deleting a requisition line item, the Request Handler 36 is normally used to perform the deletion and a Screen Flow Handler 37 is normally used to navigate the user to the next appropriate screen. Examples of various Request Handlers 36 corresponding to a Request Handler Objects 60 are provided in FIG. 6.

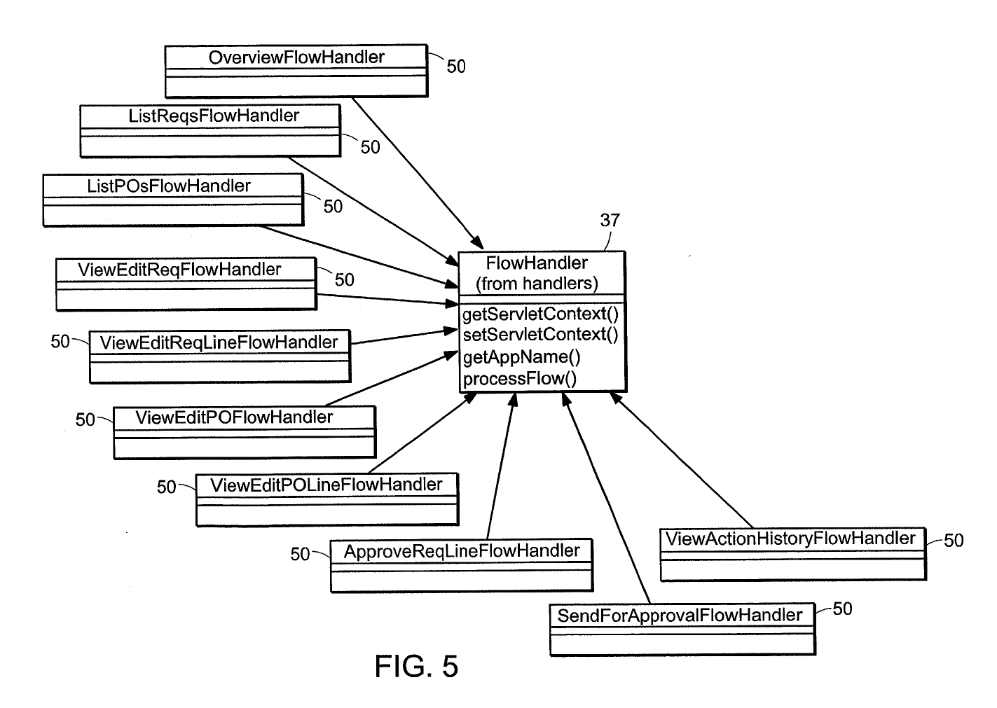

A ScreenFlowManager 35 operates in a similar way by reading the flowHandler value to create an instance of the named Flow Handler class. The ScreenFlowManager 35 returns to the FrontControllerServlet 32 a screen id that is converted into a string format of the next screen to be displayed. The FrontControllerServlet 32 uses this screen name to ensure that the given name exists within the HttpActionDT 34. If so, the FrontControllerServlet 32 then talks to the Configuration Service 39 to return the actual JSP name for presenting it to the user. Examples of various Screen Flow Handlers 37 corresponding to a FlowHandler Object 50 are provided in FIG. 5.

The communication process illustrated in FIG. 3b uses a parameter & attribute list within an HttpServletRequest 33 object to store strings and objects that make up the core information required to allow the action to complete successfully, and, consequently, to display the details of the requested screen.

Referring once again to FIG. 3b, if a new user begins to use the system and logs in for the first time, authentication of the new user has to be approved. After the approval, the new user is directed to an entry point servlet, which is depicted as the FrontControllerServlet 32 in FIG. 3b. This entry point class (called WelcomeEntryPointServlet and declared in the web.xml file) has a fixed HTTPAction, WelcomeSecurity, which is associated with handler classes in a properties file, the relevant description of which is the following:

WelcomeSecurity.useRequestHandler=false no need to request a new request handler, switching on and off

WelcomeSecurity.useScreenFlowHandler=true

WelcomeSecurity.flowHandler=com.marrakech.frameworkx.servlets.handlers.

WelcomeSecurityFlowHandler

WelcomeSecurity.targetScreenName=lNITIALISE_SECURITY

The specified properties tell the FrontControllerServiet 32 that there is no RequestHandler implementor, and that the FlowHandler implementor, WelcomeSecurityFlowHandler, should be called instead. Furthermore, the file specifies that there is only one possible “next screen” that the FlowHandler will take the user to called INITIALISE_SECURITY (note that targetScreenName is a property list, so it may contain more than one possible “next screen”). WelcomeSecurityFlowHandler then executes, performing any necessary groundwork for the next screen, storing required security credentials against the request. The user is then directed to the next screen (JSP name or servlet), mapped in the properties file as:

screen.INITIALISE_SECURITY=/InitialiseSecurity.jsp

This screen post its response to the FrontControllerServlet, which goes through the above process again, only with a new HTTPAction.

To provide a controllable solution to handling exceptional situations within the FrontControllerServlet, the present invention provides a mapping of Exceptions to HTTPActions. If an Exception occurs within the doProcess method of FrontControllerServlet, which implements the behavior described in the previous section, the Exception is mapped to an action using the properties file:

exceptionAction.com.marrakech.myapp.FinancialLimitExceededException=LimitExceeded

exceptionAction.com.marrakech.myapp.DataNotFoundException=DataNotFound

So, for example, if a DataNotFoundException is present within the doProcess method, the Exception is caught, mapped and a new doProcess is executed using the newly mapped action, DataNotFound. The new action will handle the situation in a user-friendly fashion, such as presenting an explanation message to the user and allowing the user to try their request again, instead of displaying a browser error.

If no specific mapping is found in the process of mapping an Exception to an action, the Exception inheritance hierarchy is normally increased in order to find out whether the ancestors have a mapping that can be used. For example, suppose a RequistionLimitExceededException, a descendant of FinancialLimitExceededException, was found with no specific mapping available. Still, if the ancestral mapping is found, the Exception will be mapped to the LimitExceeded action. If no suitable mapping is found, the system will return a RuntimeException .

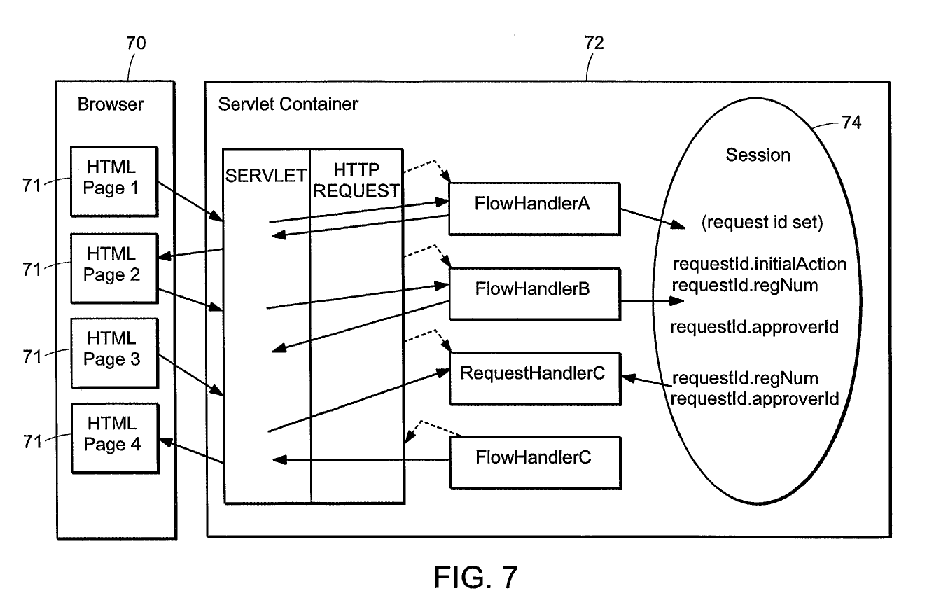

As described above, in order to complete a request, communication to and from the Servlet must specify the details of the action requested by the user, which is achieved by passing string and data objects through the parameter and attribute list located inside the HttpServletRequest object. Practically, it is not impossible for a user to invoke the same application using two different browser windows on the same computer. If such a situation happens, it is necessary to have a way to store the details of the user's interaction with the application over multiple screens. The implementation for such storage is called a request id. An example of how the request id works in the multiple browser windows scenario is illustrated in FIG. 7. If a user wishes to approve a requisition document, the user must choose the appropriate requisition for approval, enter the approving authority to review the request and enter the confirmation password to prevent unauthorized malicious use of the user's active communication session. Performing all these actions using just one screen would be to too cumbersome, so three screens 71 in browser 70 might be needed to complete the approval process. Since it is often problematic to store and retain specific context or data on the client's side for many web-based applications, the solution is to use the application server Session 74 residing within a Servlet Container 72 to store any subsequently required data. When the time comes to retrieve the stored data, the user needs to be sure that the retrieved data were actually stored by that same user. Setting the request id to the current time (in milliseconds) and preappending this information to all the key names stored in the session, ensuring that it was the same user who stored the session details before becomes a matter of passing the request id to and from the JSPs.

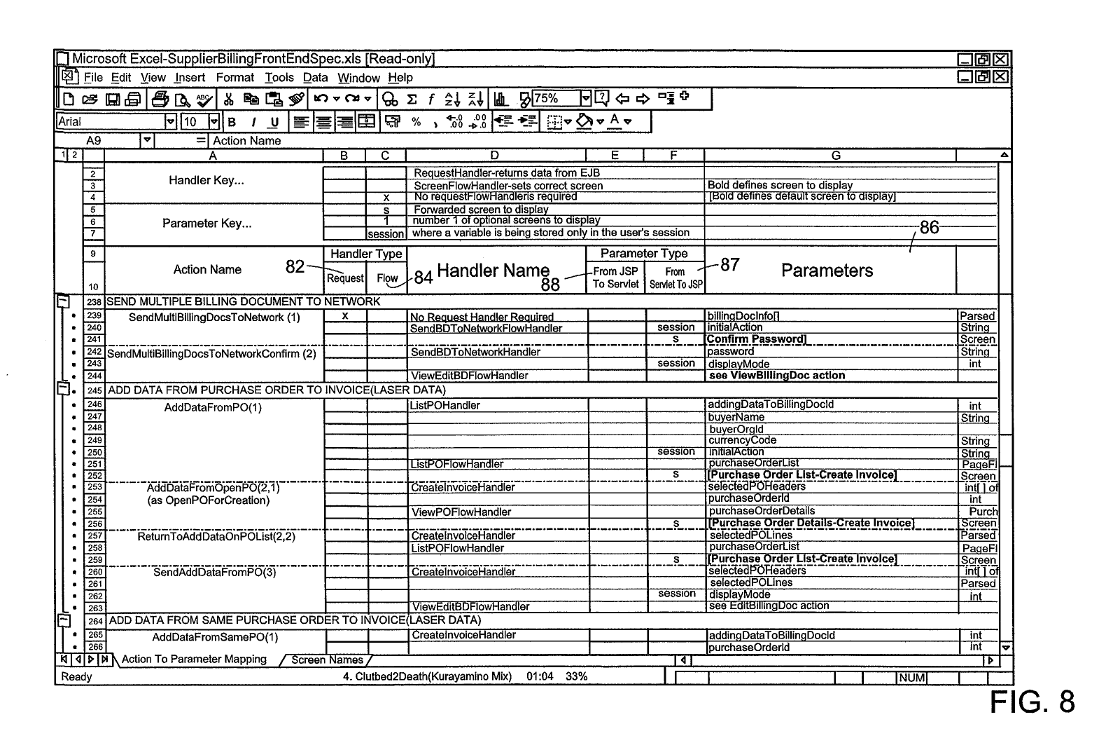

In order to be able to assemble all the necessary requirements and data within an application, a single Front End Spec was developed. It is a document guiding the developers through the writing of both the flow and request handlers, which are responsible for mapping out the action names, the handlers communicating with each action, and all the data transferred between the handler and JSP. An example of the Front End Spec document and its structure is provided in FIG. 8.

As illustrated in FIG. 8, the Front End Spec is a complete definition of actions a user can undertake, as well as all the details about the action contained in the description of the relevant action. Each action defines the following:

A Request Handler 82 that the action needs to communicate with (depending on the circumstance this handler type may not be required).

A Flow Handler 84 that the Request Handler 82 needs to communicate with. Every action needs a Flow Handler, since it is the object deciding which screen the user should be prompted to, except for the cases where only one screen is available for the user to navigate. For example, if a user wishes to logout from the application, a LogoutFlowHandler forwards the logout page to the user. There is no need to create a handler just to perform this simple log out task.

Parameters that are set in the JSP and passed by the Servlet Container to the handler. Examples of such parameters are provided in the fifth column in the Spec shown in FIG. 7, namely the column entitled “Parameter Type From JSP to Servlet” (shown as 88 in FIG. 8). The listed parameters provide the Servlet with the information necessary to allow the request to be completed without runtime errors.

Parameters that are set in a Handler and passed via the Servlet Container to the JSP. Indicated by the sixth column in the Spec entitled “Parameter Type From Servlet to JSP”, shown in as 87 in FIG. 8, the listed parameters allow us to send large amounts of data back to the JSP, so that the screen requested by the user can be displayed accurately.

The target screens for the action are highlighted, allowing the handler developer to know which screens this action can navigate to. Essentially the decision of which screen to navigate to will depend on the content of the data that the handler reads to make the decision.

Parameter names 86 are an essential part of the communication between the Handler and JSP developers, allowing the parallel development of both the Handler and JSP with an integration task and unit test on code completion.

The Data Type parameter, represented by the eighth column on the Spec (not shown in FIG. 8), offers the information for both JSP and Handler developers to convert the Parameter/Attribute list they receive into the accepted object as it was originally defined in the code.

The Notes column (not shown in FIG. 8) gives any additional and necessary information regarding the initial values or the mandatory nature of the parameters passed via the Servlet.

The level of detail specified in the Front End Spec is crucial to facilitating communication between a Handler and JSP developers. The Front End Spec document is usually written after the completion of a case requirements data dictionary, screen storyboards, and detailed mock-up screens.

Referring again to FIG. 7 and the multiple screen use scenario, it is often the case that a user needs to go through several screens to complete a single request. Multiple screens 71 are necessary to collect and assemble data and perform the steps required before commencing communication with the Session Bean. For the communication to occur, a handler needs to have the information about what all the data and steps are and in what sequence they are to be performed, which explains the fact why the concept of an action becomes important in the system and design of this invention. Especially important becomes the idea of an initialAction, which is the first action the handler deals with in the multiple screen use scenario. For example, the request “Add Data From Purchase Order to Invoice” prompts the user to work through three different screens and a final general screen where the request can be completed. The initialAction is normally set within the first screen/handler and is given the value of the string representation of that first action. The subsequent actions received in the same case allow the handler to reference the initialAction and structure the order of those subsequent actions with respect to the completion of the request.

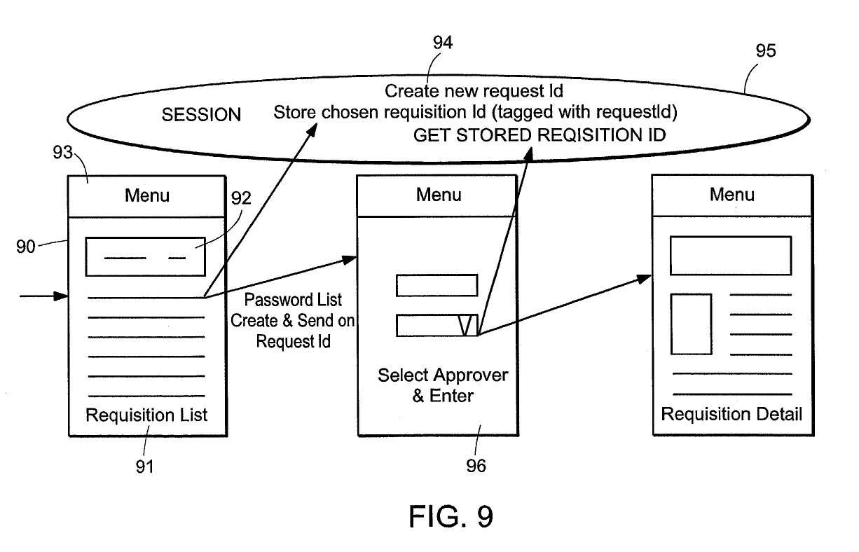

FIG. 9 illustrates what happens at the client side when a user clicks on a button initiating a request for information from a server. With the communication process described in detail above, it is not each individual request that becomes the core to the design of the communication system, but the way those requests are grouped together at the client side. Following the example of a user requesting an approval of a requisition list, the diagram in FIG. 9 shows the sequence of screens the user must click through to complete the request.

At the outset the user is presented with a screen 90 displaying a list of requisitions 91 that can be sent for approval. The user clicks to select the second requisition 92 on the list (as shown in FIG. 9) and chooses the “send for approval” function from a menu 93. The action of selecting that function results in sending a request to a server 95. The action name (as coded within the button of the JSP) is what is called the initialAction, it triggers the creation of a newly generated request id, as shown by 94 in FIG. 9. The request id allows the system to keep track of all the details that are being sent by the user to the server 95. In the example illustrated in FIG. 9 the user will be sending to the server a requisition id, which will be stored in the session with the request id appended on to it. At the final stage of this function (shown as 96 in FIG. 9), the user enters the password and selects the approving authority, specifying the additional details residing inside the session and allowing the user to proceed with the “send for approval” request. The request id communicated by the client to the server returns this previously stored information for the subsequently made requests.

At the server side, the FrontControllerServlet receives the action requested by the user and translates it into a form understood by the handlers. Located at the server side is a file specifying all actions and their attributes, wherein each attribute defines the use of a Request Handler, Flow Handler and a valid screen to navigate to. The action attributes are read when a new action is a requested and stored as meta-data corresponding to each action within the application. The handlers help us segregate and deal with various elements of the user's request. The user's request is then delegated to a Request and/or a Flow Handler, depending on the attributes of the action. The Request Handler performs the actual saving and workflow functionality, whereas the Flow Handler retrieves data to display when the user is forwarded to a predetermined screen. Principally, a Handler invokes the core to the user operations of an application, which, in turn, communicates with EJBs and other lower level objects of the system architecture. The FrontControllerServlet residing on the server acts as a window to the outside world and as a manager to any actions that are requested by the user via a browser.

1. A JSP server having a servlet residing on the server, the servlet comprising:
a configuration service comprising a configuration file, the configuration file comprising a list of details of an action;
an action manager mapping the action onto at least one request handler and at least one flow handler, the action manager being programmed to communicate with the configuration service, retrieve the configuration file and provide the configuration file to the servlet;
a request manager programmed to read the request handler information; and
a screen flow manager programmed to read the flow handler information and to communicate the flow handler information to the servlet.

2. The server of claim 1, wherein the flow handler information is an identification of a screen to be displayed to a user.

3. A server architecture comprising a server having a servlet programmed to invoke a request handler and a flow handler in response to an action initiated by a user, a request handler interface communicating with the servlet and a flow handler interface communicating with the servlet.

4. The server architecture of claim 3, wherein the server is a JSP server.

5. A method of generating and displaying a dynamically built web page to a user in response to a user's request, the method comprising:
providing a web server having a servlet;
receiving the user's request at the server and compiling a parameter list specifying an action corresponding to the request;
transmitting the parameter list to the servlet, the servlet determining whether a request handler needs to be invoked to process the action;
delegating further processing of the request from the servlet to the request handler if it needs to be invoked, or a flow handler;
using the flow handler to generate the dynamically built web page and display it to the user.

6. The method of claim 5, further comprising delegating further processing to the flow handler when no request handler needs to be invoked.

7. The method of claim 5, further comprising a screen flow manager reading the flow handler and returning a screen id to the servlet.

8. The method of claim 7, further comprising converting the screen id into a string format of the dynamically built web page.

9. A method of processing a user's request by a server having a servlet, the method comprising:
receiving information related to the user's request from multiple web browser windows by the servlet;
processing the information by the servlet and passing the information to one or more handlers;
initiating communication between one or more handlers and an enterprise java bean, the communication based on the information passed by the server;
receiving a response from the enterprise java bean and passing the response to the servlet, the servlet using the response to complete the user's request.

10. The method of claim 9, wherein one or more handlers comprise a request handler and a flow handler.
